(19) United States
(12) Patent Application Publication
(10) Pub. No.: US 2008/0231250 A1
(43) Pub. Date: Sep. 25, 2008

(54) Method and Assembly For Supplying Power to an Active Independent Component

(76) Inventor: Marc-Alain Weber, Annecy (FR)

Correspondence Address: ARENT FOX LLP, 1050 CONNECTICUT AVENUE, N.W., SUITE 400, WASHINGTON, DC, 20036, US

(21) Appl. No.: 12/064,545

(22) PCT Filed: Aug. 8, 2006
(86) PCT No.: PCT/FR2006/001910

§ 371 Date: Apr. 9, 2008

(30) Foreign Application Priority Data
Aug. 23, 2005 (FR) 0508680

(51) Int. Cl. H02J 4/00

(52) U.S. Cl. 323/318

(57) ABSTRACT

The invention relates to a method for supplying power to an independent active component and to assembly comprising a rolling bearing and an independent electronic system (8) comprising at least one active component, wherein said assembly comprises at least one area displaying the variations of at least one state during the bearing rotation. Said assembly is characterised in that said area is provided with a substrate (9) comprising means (10) for converting said variations into electric signal, the electronic system is mounted on the substrate (9) together with the active component electrically communicating with the conversion means (10) by means of a signal operating device which is integrated into the system and is used for converting the electric signal into current required for electrically feeding said active component.

The invention relates to a method for supplying electric power to at least one active component of an independent electronic system belonging to an assembly comprising a rolling-contact bearing, and said assembly.

In the scope of the use of such assembly, it is more and more often necessary to have information on operation and/or identification parameters of said assembly. More particularly, such information is used to optimize the operation of the assembly and/or its maintenance.

For this purpose, it is known to provide an electronic system comprising an active component capable of supplying relevant information when necessary.

More particularly, in many applications, it is desirable to provide an active component which is independent as regards electric power supply so as to be independent more particularly from a wire connection between such component and the assembly environment.

In these embodiments, the problem of electric power supply of the independent active component over time remains a problem. In order to try to solve such problem, many embodiments have been developed. More particularly, it has been provided to use an element of the piezo-electric type comprising a seismic mass to convert into electric energy a mechanical energy generated during the operation of the assembly.

However, this type of solution is limited by the constraints of the integration of the electronic system and its power supply into the assembly, more particularly as regards dimensions and weight. Consequently, for each considered integration, it is necessary to provide for a specific development of the electronic system, as well as the piezo-electric element, which limits the modularity of the known solutions.

The aim of invention is more particularly to solve the above mentioned problems by providing a method and an assembly which make it possible to use a power supply special to said assembly, in order to supply electric power to an active component while improving the modularity of the solution as regards mechanical and electrical integration constraints.

For this purpose, and according to a first aspect, the invention provides a method for supplying power to at least one active component of an independent electronic system belonging to an assembly comprising a rolling-contact bearing, said assembly comprising at least one area displaying the variations of at least one state during the bearing rotation, said method providing:
to provide said area with a substrate comprising means for converting said variations into an electric signal, said means being so arranged, depending on the characteristics of the variations and those of the area, as to supply a sufficient electric power for supplying the active component;
to integrate into said electronic system an operating device which is so arranged as to convert the electric signal into current required for the electric supply of the active component;
to mount the electronic system onto the substrate by placing the active component electrically communicating with the conversion means by means of the operating device, so as to supply said active component with the electric power.

According to a second aspect, the invention provides an assembly comprising a rolling-contact bearing and an independent electronic system comprising at least an active component, said assembly comprising at least one area displaying the variations of at least one state during the bearing rotation, said assembly being characterized in that said area is provided with a substrate which includes means for converting said variations into an electric signal, said electronic system being mounted on the substrate together with the active component electrically communicating with the conversion means by means of a signal operating device which is integrated into said system, said operating device being arranged to convert the electric signal into current required for the electric supply of the active component.

Other objects and advantages of the invention will appear more clearly while reading the following description and referring to the appended drawings in which:

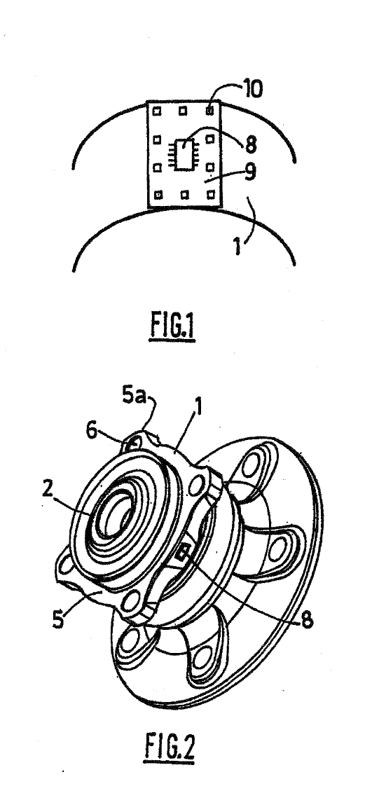

FIG. 1 is a schematic view of an assembly comprising a rolling bearing, the outer ring of which is provided with a substrate on which an electronic system is mounted in order to supply electric power to an active component of said system;

FIG. 2 is a perspective view of an assembly comprising a rolling bearing of the wheel of a motor vehicle, the outer ring of said rolling bearing being equipped according to FIG. 1.

While referring to the Figures, an assembly is described which comprises a rolling bearing for the wheel of a motor vehicle. However, the invention is not at all limited to such specific application, since it can be applied to any type of assembly comprising a rolling-contact bearing, for the automobile industry or for any other technical field.

In FIG. 2, the rolling bearing comprises a fixed outer ring 1, a rotating inner ring 2 and rolling elements positioned in a known way between said rings to allow the relative rotation of rings 1 and 2. The fixed ring comprises a flange 5 provided with four protrusions 5a positioned substantially at 90° from each other, in each of which a hole 6 for fastening it to the frame is provided.

During the utilization of the assembly, the flange 5 is submitted to important mechanical constraints which induce a deformation thereof. More particularly, during the rotation of the rolling bearing, the periodical passage of the rolling-contact elements induces periodical local deformations of the outer ring 1 and thus deformation of the flange 5. According to an embodiment, the invention provides to use such periodical local deformations for supplying at least one active component of an electronic system 8 which belongs to the assembly.

As an alternative or as a supplement, other areas of the assembly displaying mechanical deformations or variations from another state, such as the vibrations of the assembly or the temperature, can be used to generate electric power. More particularly, the rotating inner ring can be provided according to the invention.

The active component can be formed by at least one sensor of one assembly operation parameter, such as a vibration, position, speed, temperature, moisture, or wear sensor.

In addition or as an alternative, an active identification component can be provided, such as a radiofrequency label of the RFID type, in which information relating to the assembly or its environment can be written and/or read.

The electronic system 8 is independent as regards power supply, which means that it can be independent from any wire connection between the assembly and the external environment thereof. Thus, the operation of the electronic system 8 does not interfere with that of the assembly.

For this purpose, the invention provides to provide the flange 5 with a substrate 9 comprising means for converting the variations into electric signal. The means 10 are so arranged more particularly as regards their geometry and/or their disposition on the area, to supply a sufficient electric power for supplying the active component. Such adaptation of the conversion means more particularly depends on the characteristics of the deformations, of the area and on the conditions of use of the assembly, so as to supply a sufficient electric power.

Besides, an operating device which is so arranged as to convert the electric signal into current required for the power supply of the active component is integrated into the electronic system 8. More particularly, the operation system makes it possible to shape an electric signal and to adapt it to the active component. The integration of the operation system into the electronic system 8 makes it possible to satisfactorily meet the requirements of the assembly and of the standardization, more particularly because it does not provide the installation of a separate electronic system for generating the electric power.

According to the invention, it is provided to mount the electronic system 8 on the substrate 9 by electrically communicating the active component with the conversion means by means of the operating device, so as to supply the said active component with electric power.

It is thus possible to develop a standard electronic system 8, more particularly having a standard packaging case for a range of assemblies, which is mounted on the substrate 9 which is specific to the area so as to supply the required electric power. Such embodiment makes it possible to use the same electronic system 8 for various assemblies or a same assembly under various conditions of utilization or in various areas.

Further, as the electronic system 8 is mounted on the substrate 9, the integration of said system into the assembly is therefore simplified. Besides, it is possible to configure the substrate 9 so that it can display mechanical characteristics of protection of the electronic system 8 during the assembling operation. As a matter of fact, the substrate 9 is used as an interface between the electronic system 8 and the assembly area.

Referring to the Figures, an embodiment of an assembly wherein the conversion means 10 are based on a piezoelectric material is described. As an alternative, when the state varying during the bearing rotation is temperature, the conversion means 10 can be based on a thermo-electric material. Further, conversion means 10 can be provided, based on piezo-electric material and thermo-electric material.

In the embodiment shown, the substrate 9 is composed of a plate of material for example ceramics, which is associated on a side face on the flange 5, for example by gluing or similar. More particularly the provided area on the substrate is selected to display large deformations, for example between the first two protrusions 5a.

The substrate comprises a coating composed of a discrete network of the piezo-electric, for example a polymeric material. Such embodiment makes it possible to localize the conversion of energy on areas of the substrate where the amplitudes of the periodical deformations are maximum, for example by optimizing the disposition of the piezo-electric material. Besides, the substrate 9 has a function of transmitting deformations which can be optimized, so that for example it can concentrate said deformations at the level of the piezo-electric material.

As an alternative, it can be provided that the coating is continuous or that the substrate is made directly of piezo-electric material, for example of the ceramic type. In such embodiments, the shape, surface and thickness of the piezo-electric material can be adapted, more particularly as a function of the characteristics of the periodical deformations, so as to supply sufficient electric power to supply the active component with electric power. Typically, in the assembly according to FIG. 2, the recoverable power is of the order of 3 μWatt/cm³, because of a piezoelectric effect, and of the order of 40 μWatt/cm³, because of a Peltier effect.

In the embodiments described, the piezo-electric conversion means 10 has no seismic mass, which facilitates their integration in the assembly.

The electronic system 8 is, for example, in the form of an electronic microsystem or of a micro-electromechanical system (MEMS), which integrates an operating device for example composed of an electronic circuit known by a specialist in the art. Such type of system 8 has the advantage of being capable of integrating several functions within reduced dimensions while ensuring a protection of the electronic components. Besides, it can be connected in a standard way, for example using connection tags protruding from the packaging box.

The electronic system 8 can integrate at least one of the means selected in the group comprising:
means for storing and managing energy, for example, in the form of a rechargeable battery;
means for processing the signals from the active component, for example in the form of software means and means for storing data which can be integrated into an ASIC;
means for a radio-electrically communicating with the active component; for example including a low consumption radiofrequency emitter with an integrated antenna which enables the active component and a signal receiving and processing external central unit to communicate.

Although the description has been made in relation with a substrate made integral with the bearing outer ring, it can be provided to equip another area of the assembly or the rolling bearing, for example with a sealing joint, or the rotating ring of the latter. Besides, several substrates can be provided on various areas to supply electric power to several active components which would be required for the assembly.

1. A method for supplying power to at least an active component of an independent electronic system (8) belonging to an assembly comprising a rolling-contact bearing, said assembly comprising at least one area displaying the variations of at least one state during the bearing rotation, said method providing:
to provide said area with a substrate (9) comprising means for converting (10) said variations into an electric signal, said means being so arranged, depending on the characteristics of the variations and those of the area, as to supply a sufficient electric power for supplying the active component;
to integrate into said electronic system (8) an operating device which is so arranged as to convert the electric signal into current required for the electric supply of the active component;
to mount the electronic system (8) onto the substrate (9) by placing the active component electrically communicating with the conversion means (10) by means of the operating device, so as to supply said active component with the electric power.

2. A method for supplying power according to claim 1, characterized in that
the state variations are selected in the group comprising the vibrations, the periodical deformations of the bearing induced by the rotation of said bearing and the variations in temperature.

3. A method for supplying power according to claim 1 or 2, characterized in that the geometry and/or the disposition of the conversion means (10) is adapted to supply a sufficient electric power for supplying the active component.

4. An assembly comprising a rolling-contact bearing and an independent electronic system (8) comprising at least an active component, said assembly comprising at least one area displaying the variations of at least one state during the bearing rotation, said assembly being characterized in that said area is provided with a substrate (8) which includes means for converting (10) said variations into an electric signal, said electronic system being mounted on the substrate (8) together with the active component electrically communicating with the conversion means (10) by means of a signal operating device which is integrated into said system, said operating device being arranged to convert the electric signal into current required for the electric supply of the active component.

5. An assembly according to claim 4, characterized in that the electronic system (8) comprises at least one active component formed by a sensor of the assembly operation parameter.

6. An assembly according to claim 4, characterized in that the electronic system (8) comprises at least one active identification component.

7. An assembly according to claim 4, characterized in that the electronic system (8) integrates at least one of a means for storing energy, a means for processing the signals from the active component, and a means for radio-electrically communicating with the active component.

8. An assembly according to claim 4, characterized in that the conversion means (10) are based on a piezo-electric material and/or a thermo-electric material.

9. An assembly according to claim 4, characterized in that the substrate (9) integrates conversion means (10).

10. An assembly according to claim 4, characterized in that the substrate (9) comprises a coating incorporating the conversion means (10).

11. An assembly according to claim 10, characterized in that the coating comprises a discrete network of conversion means (10).

12. An assembly according to any one of claims 4 to 11, characterized in that the substrate (9) is made integral with one element (1, 5) of the rolling-contact bearing.

13. An assembly according to claim 12, characterized in that the element is selected in the group comprising the rolling-contact rings (1) and the rolling-contact sealing joint.
